(19) United States
(12) Patent Application Publication
(10) Pub. No.: US 2014/0077484 A1
(43) Pub. Date: Mar. 20, 2014

(54) FRAC TANK AND TRAILER ASSEMBLY

(71) Applicant: John M. Harrell, Seguin, TX (US)

(72) Inventor: John M. Harrell, Seguin, TX (US)

(21) Appl. No.: 14/069,811

(22) Filed: Nov. 1, 2013

Related U.S. Application Data
(63) Continuation-in-part of application No. 13/480,714, filed on May 25, 2012.
(60) Provisional application No. 61/490,268, filed on May 26, 2011.

(51) Int. Cl. B60P 3/22

(52) U.S. Cl. CPC B60P 3/2205
USPC 280/837

(57) ABSTRACT

Applicant provides a novel tank and trailer assembly adapted to receive fluids, including frac fluids therein, at a wellsite. The frac tank of the tank/trailer assembly is comprised of a fabric composite material rather than steel. This makes the frac tank lighter and easier to haul (empty) over the highway. The frac tank and trailer assembly disclosed may even be hauled with a pickup truck and may use a gooseneck or fifth wheel connection.

This utility patent application is a continuation-in-part of and claims priority to and benefit of U.S. patent application Ser. No. 13/480,714, filed May 25, 2012, which claims priority to U.S. Provisional Application Ser. No. 61/490,268, filed May 26, 2011.

### FIELD OF THE INVENTION

Frac tanks, namely, a frac tank assembly comprising a composite tank and a trailer adapted to carry the composite tank.

### BACKGROUND OF THE INVENTION

Frac tanks are used in the oil field for providing fluids to oil wells or for storage of fluids. The fluids may be water, salt water, acids from drilling muds, and the like.

Prior art frac tanks are typically cylindrical or rectangular and made of steel and configured and shaped so that they can be pulled by a tractor, diesel, semi-truck or other suitable vehicle. Most steel frac tanks have a single axle with multiple wheels at a removed end thereof and are engaged with the tractor to pull them to and from the oil field. At a receiving site, a multiplicity of the frac tanks are typically used to receive fluids for use with the well. For the fluids received in the frac tank are subsequently emptied into road-going tankers which take it for offsite disposal.

### SUMMARY OF THE INVENTION

Applicant provides a novel frac tank and trailer assembly, wherein the frac tank is comprised of a composite substrate material, such as fiberglass, rather than steel and wherein the trailer is uniquely adapted to carry the frac tank with a number of features novel to frac tank and trailer assemblies with the weight advantage of Applicant's composite tank, a winch truck is not needed.

A frac tank/trailer combination is disclosed typically comprising a pickup truck or a tractor, a frac tank assembly including a frac tank constructed from a fiberglass or composite material, and a trailer assembly adapted to engage a pickup truck or tractor.

Applicants disclose a frac tank and trailer assembly with digester aerator turbine.

Due to massive amounts of water needed for fracing, the addition of an aerator, such as a self-aspirating aerator to the frac tank assembly is for the primary purpose of reuse or reclamation of polluted or contaminated fluids. One example of a turbine is the Toring turbine model tt220 available from VaraCorp, Austin, Tex. This type of aerator introduces microscopic and small bubbles of oxygen containing air beneath the surface to provide dissolved oxygen or other reactant gas. In one example, oxygen is used to rapidly increase aerobic microbes. This is needed to help remove some of the chemicals in frac flowback water so that some can be reused.

Current practices are to haul all flowback and production water off site to disposal wells The cost for this portion of drilling and completion operations could be reduced by the use of the turbine. With continued use during production, this could reduce lift costs as well. Aeration systems currently in use are permanent installations such as wastewater facilities, golf course ponds, animal waste lagoons, and the like. The lightweight and portability of the tank assembly allows this unit to be relocated with a pickup truck as needed. High oxygen levels produced during operation of the aerator will rapidly eat through metal tanks unless coated with expensive anti-oxidation products. The composite tank is resistant to oxidation which makes the assembly more cost effective.

Applicant provides a novel method of portable treatment as needed for all types of wastewater applications where high levels of dissolved oxygen or other gas is needed to help clean the water for reintroduction into the environment or reuse in high water use operations.

When frac water is injected into a formulation, it picks up contaminants naturally present such as calcium bicarbonate, magnesium sulfate, strontium, sodium chloride, iron, and barium. In addition, the returning fluid contains heavy metals, soap, radiation, and other components. When sufficient amounts of dissolved oxygen are introduced into the frac water and allowed adequate contact time, the water changes from an anaerobic to aerobic state. The treatment process then follows two pathways. First, the dissolved oxygen kills anaerobes such as sulfate reducing bacteria (SRB). In turn, the dissolved oxygen supports the growth of aerobes that will digest any floating or subsurface hydrocarbons, bringing clarity to the water. Second, the dissolved oxygen transforms solids such as iron and manganese to their oxidized states which allows them to be removed or else settle to the bottom of the tank.

Oxygen also is known to oxidize dissolved contaminants such as hydrogen sulfide. It can remove volatile gaseous compounds such as ammonia and carbon dioxide.

### BRIEF DESCRIPTION OF THE DRAWINGS

FIG. 1 is a front elevational view of Applicant's tank/trailer assembly without the gooseneck assembly thereon.

FIG. 2 is a side elevational view of the tank/trailer assembly.

FIGS. 2A and 2B are side elevational views of two embodiments of the rear axle assembly, fixed in FIG. 2A, and pivoting in FIG. 2B. FIG. 2A also illustrates the tank/trailer assembly with a pickup truck engaged therewith. FIG. 2C is a perspective, partly cutaway view of a composite frac tank having internal strengthening members.

FIG. 3 is a rear elevational view of Applicant's tank/trailer assembly with the pivoting rear axle assembly embodiment.

FIGS. 4A and 4B are partial side elevational views of the pivoting rear axle assembly; FIG. 4A in a use position; FIG. 4B with the tank resting on a support surface, such as the ground.

FIGS. 5 and 6 are top and side elevational views of the tank assembly separate and apart from the trailer assembly.

FIGS. 7, 8, and 9 are top elevational, cross-section and side elevational views of the trailer assembly apart from the tank assembly.

FIGS. 10 and 11 are top elevational and side elevational views of Applicant's tank and trailer assembly illustrated in a manner in which the two elements are secured to one another.

FIGS. 12 and 13 illustrate detail views of the securement straps which affix the tank member to the trailer assembly to the longitudinal members thereof.

FIG. 14 is a side isometric view of the tank and trailer assembly at the front portion thereof showing the manner in which the tank and trailer assembly engage one another.

FIGS. 15 and 16 are side and rear elevational views, respectively, having an alternate preferred embodiment of Applicant's invention

FIGS. 15A and 16A are side elevational views of two embodiments of Applicant's frac tank and trailer assembly.

FIG. 17 is a side elevational view of Applicant's tank/trailer assembly having configured frame members, resting on the ground and containing a stored fluid.

FIGS. 18 and 19 show two methods of manufacturing a frac tank member.

FIGS. 20 and 21 illustrate cross-sectional views of part of the walls of Applicant's frac tank member.

### DETAILED DESCRIPTION OF THE PREFERRED EMBODIMENT

This patent application incorporates by reference U.S. Pat. Nos. 4,406,471 (Holloway, 1983) (rear wheels lower), and 5,628,425.

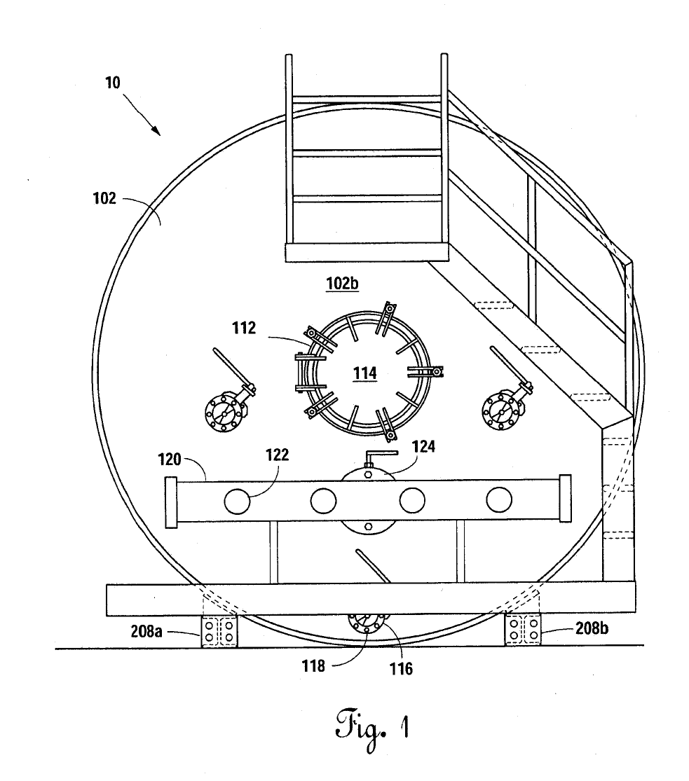

FIGS. 1, 2, 2A, 2B, 3, 4A and 4B illustrate various views of Applicant's novel tank/trailer assembly 10. Applicant's tank/trailer assembly 10 may be adapted to be carried by a pickup truck PUT or tractor as more particularly set forth below.

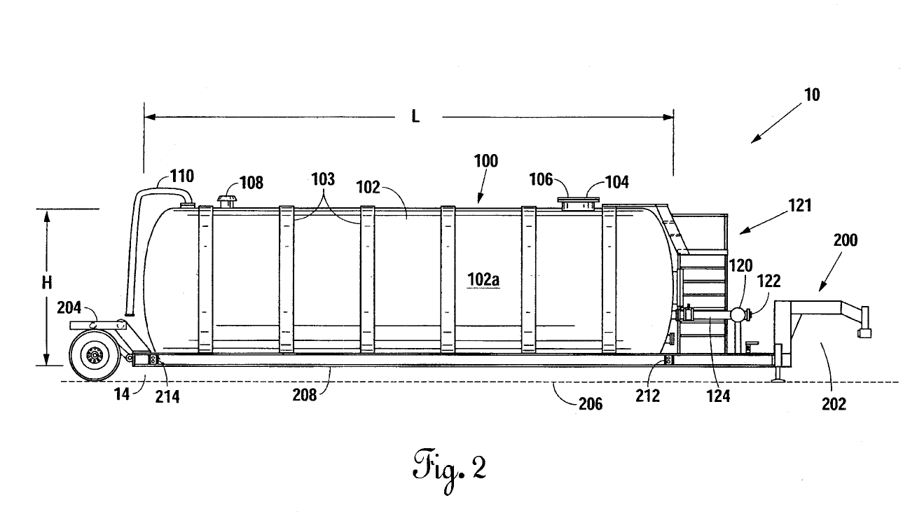

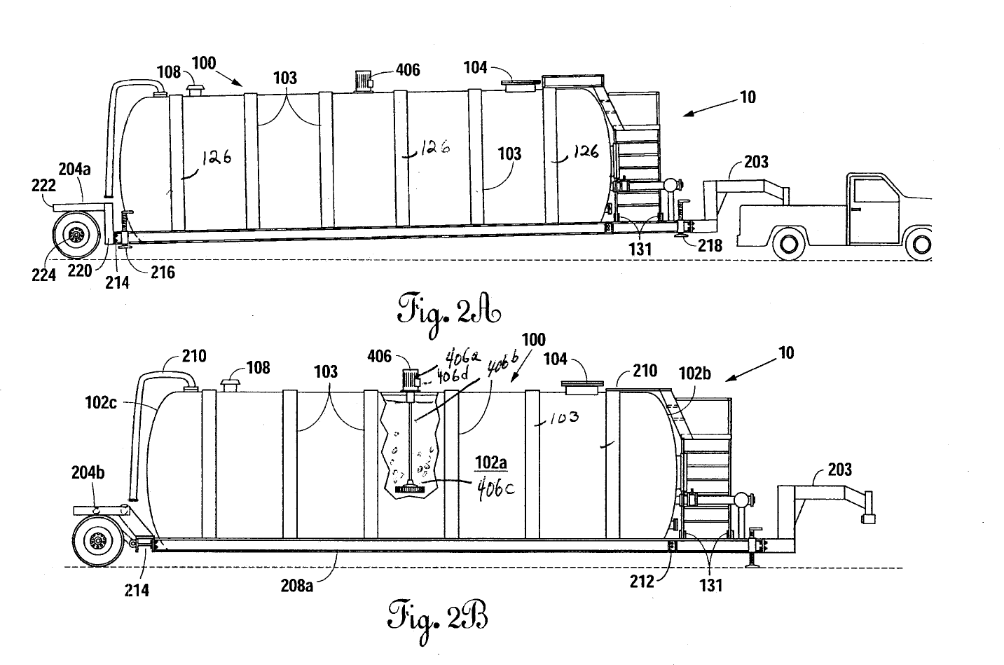

A tank assembly 100 is provided in combination with a trailer assembly 200 and other related structures which may compromise Applicant's tank/trailer assembly 10. Tank/trailer assembly 10 is designed to engage, in one embodiment, a pickup truck PUT (see FIG. 2A) and to easily and effectively transport a novel empty tank assembly 100 on the unique trailer assembly 200, which trailer assembly is adapted to both effectively carry a load and to secure a walled tank member 102 (empty) of the tank assembly 100 thereon. Tank assembly 100 functions as frac tanks in the prior art are known to function, that is, to receive waste fluids at a well site and to retain them until they may be emptied in ways known in the art.

It is seen that tank assembly 100 may include an impermeable walled tank member 102. Walled tank member 102 is typically comprised of walls, impermeable with respect to typical frac liquids received therein. Walled tank member 102 may be any shape, rectangular, cylindrical or the like. In a preferred embodiment, it is comprised of a generally cylindrical shaped member, which may have a tube portion 102a, a front wall portion 102b, and a rear wall portion 102c. Strengthening members or straps 103 are typically built into the tank member 102 during construction thereof. They may be built into the walls as the composite is laid up or may attach to the outside after the tank is completed. In one embodiment, the strengthening straps are metal and external, and not integral with the composite walls. They may be external or internal. FIG. 2C shows internal straps 103 configured of a composite, such as fiberglass, laid in and integral with the walls. in the form of multiple rings 103a. All the portions 102a/102b/102c/103 may be integral with one another and are dimensioned so that they may be received on trailer assembly 200 and carried over the highway. Typical dimensions of tank member 102 may include length L equals about 24 feet to 42 feet; height H equals about 8 feet to 12 feet. Weight of the tank assembly 100 may be about 5,000-10,000 pounds (empty) with the entire tank/trailer assembly being between about 7,000-15,000 pounds (empty).

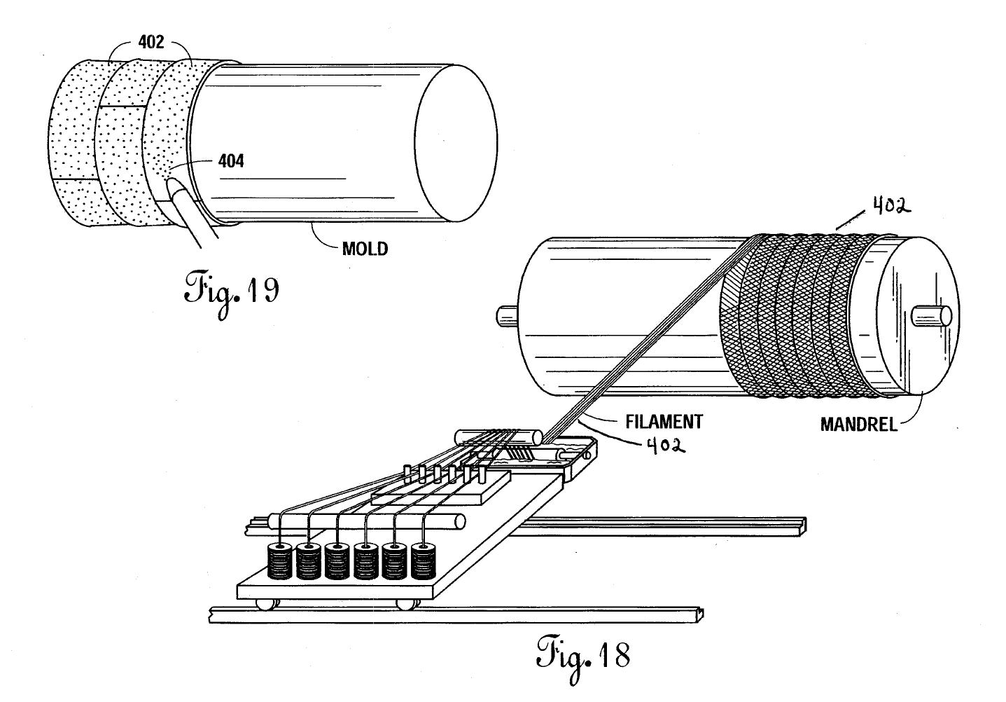

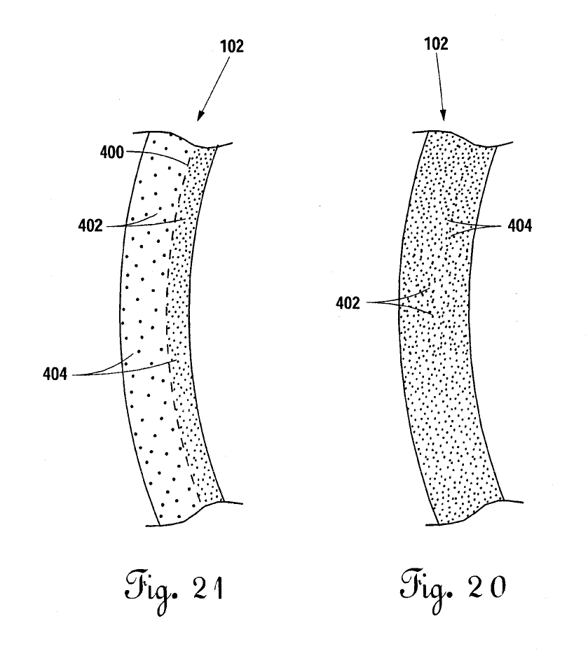

Turning to FIGS. 20 and 21, it is seen that impermeable walled member 102 may be uniquely comprised of a composite material 400. Composite material may be a substrate 402 of fiberglass fabric, carbon fiber fabric, Kevlar or other suitable composite materials. Fiberglass or other substrate may comprise one or a multiple of fabric sheets which are laid up over a suitable mold, and which may be bound by a gel or resin 404. The fiberglass may be laid up on mold M from multiple sheets of cloth, whole or chopped, and covered or impregnated with resin 404 (see FIG. 19). The fiberglass or other material may be sprayed from a chopper gun or applied by winding a fiber or filament single or multi-strand substrate on a mandrel (see FIG. 18 and the U.S. Pat. No. 5,628,425 Patent incorporated herein by reference) or in other ways known in the art. The use of fiberglass or other suitable composite provides a weight savings without a significant loss of strength, allowing the use of a pickup truck rather than a tractor to pull the tank/trailer assembly 10.

In one embodiment, side wall thickness are: about ¼″-1″ thick; preferably about ⅜″-¾″, most preferably about ½″ thick. End walls 102b/102c or caps add about ¼″. One unique resin 404 that may be used partly or entirely is a vinyl ester 404a, which resin may be particularly resistive of certain acidic corrosive liquids that may be carried in the tank assembly 100. This may, typically, coat the inner walls of the tank member 100. FIG. 21 shows inner portions of some or all of the walls having vinyl ester resin 404a, but vinyl ester resin may be all or part of the resin used. In FIG. 21, the vinyl ester is the inner ⅛″-¼″ of the wall thickness.

Other inner wall coatings or resins may be used on the inner surface of walled member 102, which coatings may further protect the composite or fiberglass material comprising the walled members from attack by corrosive liquids (like acids) held therein. These coatings include: Halogenated unsaturated polyester (HAL), Bisphenol A (BIS A), propylene glycol/isophthalic acid (PG/PIA), and Eastman TMPD™ glycol/propylene glycol/isophthalic acid (TMPD™/PG/PIA).

In one embodiment, a half inch side wall has ⅛″ inner resin coating of vinyl ester and the remainder is isothermic polyester resin.

Walled member 102 typically comprises a multiplicity of openings that are functionally and structurally and locationally positioned as is found in the prior art. For example, tank assembly 100 may include main top opening 104 having a removable main top opening cover 106. An air vent/overflow 108 may be provided as may a fill pipe 110. Inspection openings (man ways) 112 may be provided with a removable cover 114. Drain openings 116 with a drain opening cover may also be provided. Typically a discharge manifold 120 is provided with a multiplicity of discharge manifold openings 122. A manifold connect tube 124 may be provided. A multiplicity of discharge openings would provide for rapid discharge filling of the frac tank with liquids. Stairs 121, such as those made of steel, may be used as known in the art.

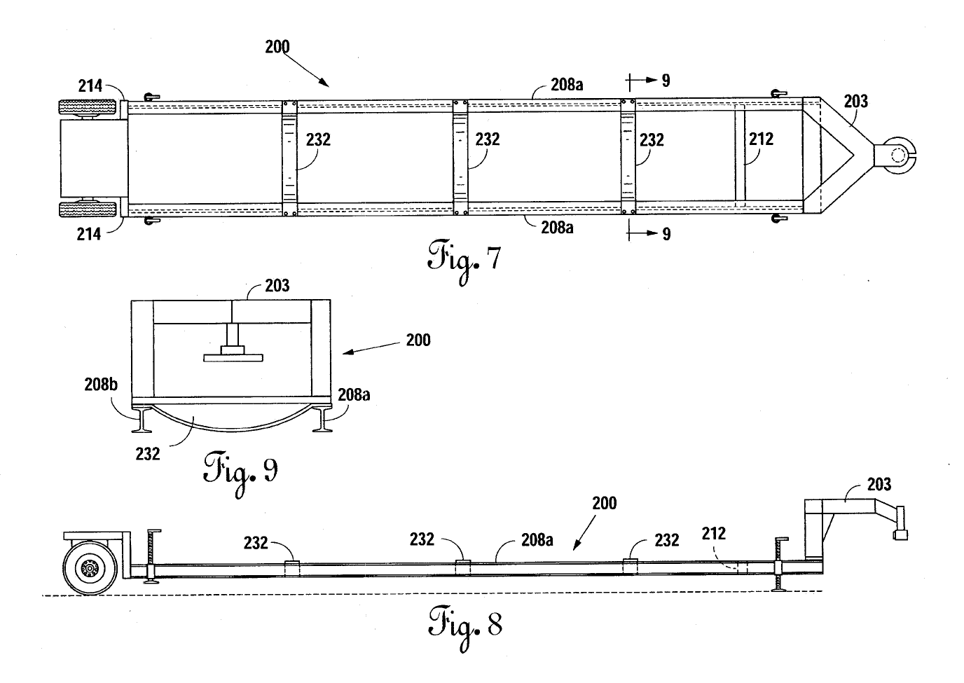

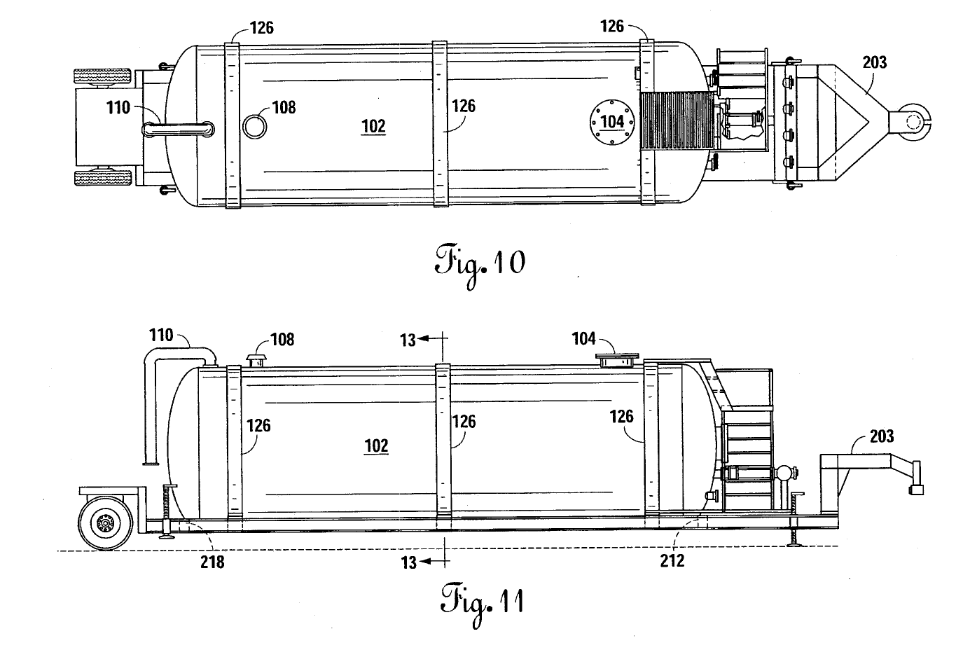

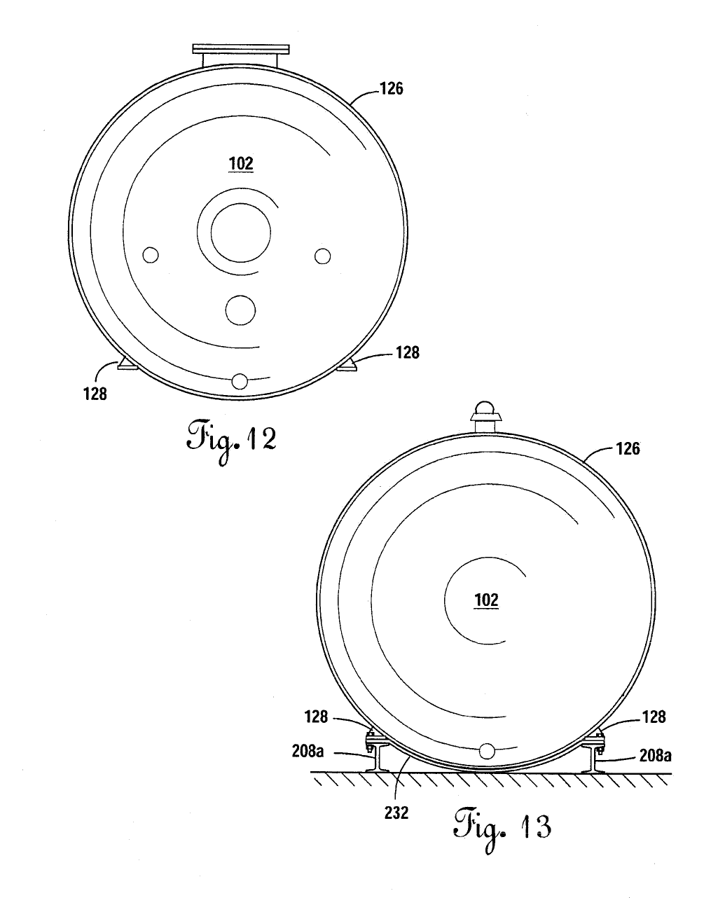

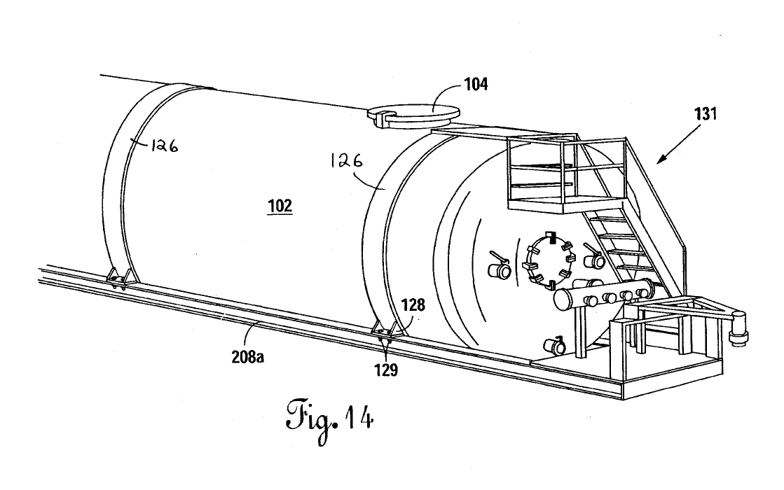

A trailer assembly 200 is provided, seen apart from the tank/trailer assembly 10 in FIGS. 5-13. Trailer assembly 200 may include a truck engagement assembly 202 at the front thereof, which truck engagement assembly is, in a preferred embodiment, a gooseneck or fifth wheel arrangement adapted to engage a pickup truck or tractor. Because Applicant's use of a lightweight, durable, fiberglass or composite material for walled member 102, sufficient weight savings is provided so that a pickup truck may be used to haul tank/trailer assembly 10. With pickup truck PUT being used, a gooseneck apparatus 203 may be included in truck engagement assembly 202.

At the removed end is seen a rear axle assembly 204, the details of which are set forth below. Between truck engagement assembly 202 and rear axle assembly 204 is a tank support assembly 206. It may be comprised of a multiplicity of longitudinal members, here, longitudinal members 208a/208b. Longitudinal members are typically spaced apart to receive and support the cylindrical walls as illustrated in FIG. 1. Longitudinal members 208a/208b typically extend up to about the length L of the tank and typically slightly beyond and engage front cross-brace 212 of the front and rear cross-brace 214 at the rear so as to provide a rigid boxlike structure to cradle the underside or the lower portion of walled member 102 when a cylindrical configuration is used, with the cross-members typically bracketing the tank to prevent excessive fore and aft movement of the tank on the trailer.

Turning to FIG. 2A, it is seen that jack assembly 216 may be provided engaging the rear of the trailer assembly, for example, at one or both longitudinal members 208a/208b, as well as jack assembly 218 for engaging the front of the trailer assembly. Rear jack assembly may be used whenever it is necessary to raise the rear of the tank. Front jack assembly 218 may be used when it is necessary to remove the front tank/trailer assembly 10 from the pickup truck and set the tank/trailer assembly on the ground at the well site.

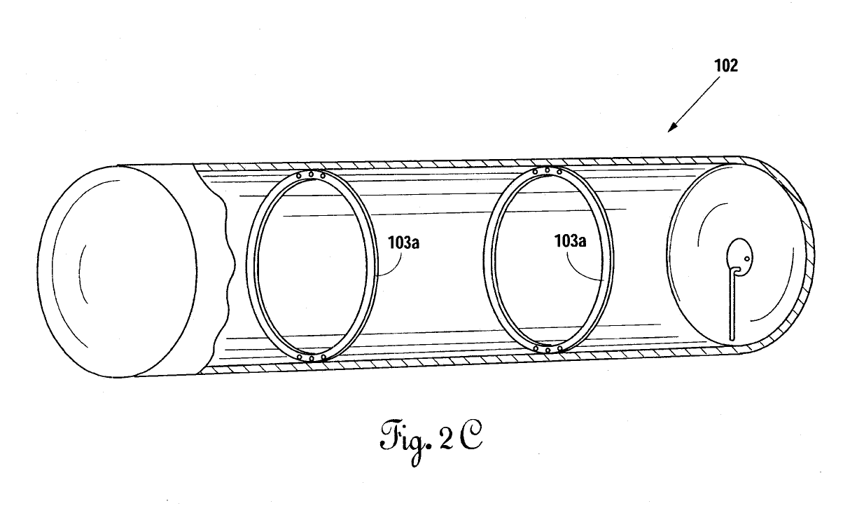

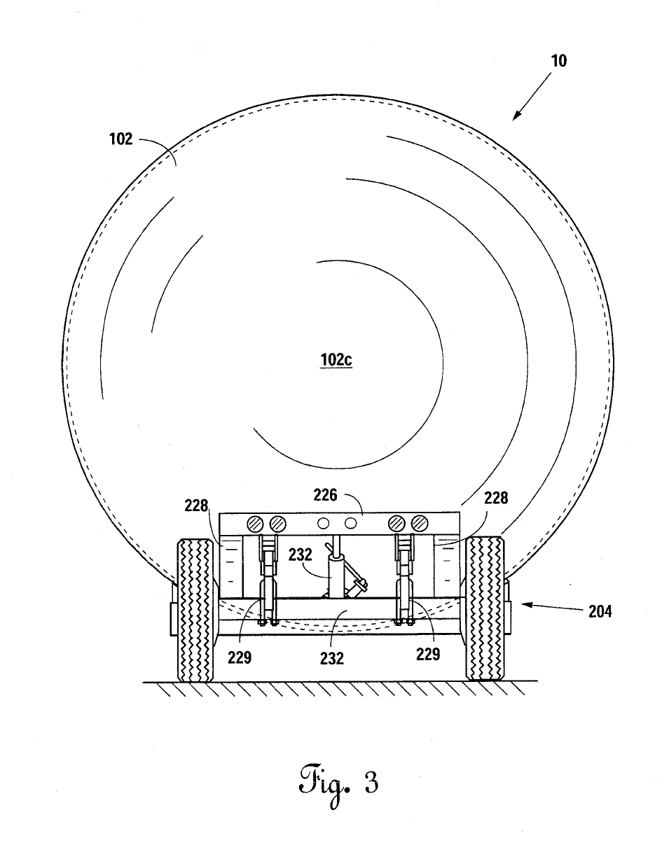

There may be two different embodiments of rear axle assembly 204. Here, a first embodiment 204a is seen in FIG. 2A, and a second embodiment 204b is seen in FIGS. 2, 2B, 4A, and 4B.

In embodiment 204a, rigid uprights 220 spaced apart, extend from cross-member and/or removed ends of the longitudinal members and have a rigid axle platform 222 engaged so as to form the structure illustrated in FIG. 2A. This is a rigid structure and axle 224 is mounted to any number of structural members, typically 222 and/or elements 220 in known ways. In embodiment 204a, a jack, such as jack 216, may be used when raising the rear of the trailer as desired.

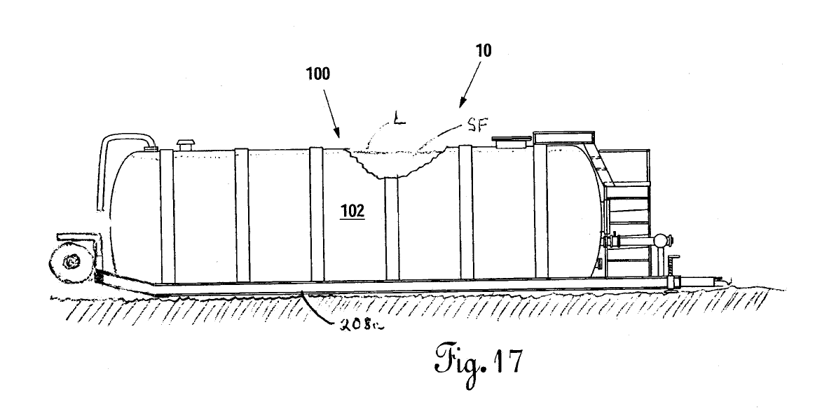

The rigid structure, with an axle that does not drop down as set forth in embodiment 204b, may be used without the jack at the rear. This is done by dimensioning the lowest point of the trailer assembly such that when the assembly is disengaged from the tow vehicle, and the front is lowered to the ground by the use of, for example, front jack 218, the tank cradle or frame may rest on the ground. That is to say, as with some present steel frac tanks having fixed (non-pivoting) rear axles, removal of the front hitch and lowering the frac tank cradle or frame to the ground allows the rear axle and the wheels to be unloaded, since the tank cradle or frame rests on the ground. In the tank/trailer assembly 10 disclosed, the same configuration may be used with the removal from the tow vehicle and lowering of the front of the assembly allowing the rear to touch and unload the rear axle and wheels. This is typically done at the well site with an empty frac tank, which is then filled and emptied as known in the art. FIG. 17 shows angled longitudinal members as known in the art. These are typical with steel frac tanks with non-dropdown rear axle assemblies.

Turning now to embodiment 204b, it is seen that pivot platform 226 is provided which is pivotally engaged to rigidly mounted standoffs 228. Standoffs 228 are typically angled as seen in FIGS. 4A and 4B, and may be mounted to rear cross brace 214 or other elements. Pivot bearing means 230 may be provided between the removed end of element 228 and the near end of platform 226. A hydraulically/pneumatically actuated cylinder member 232 may be provided between rigid or fixed elements 228/214 or at 208, and pivoting element 226. Pivot platform 226 will engage, through suspension means 229, such as shock absorbers, leaf springs, and the like, or in other ways known in the art, axle 224. Providing pivoting action between pivot platform 226 and rigid, fixed or non-moving elements of the trailer assembly allows the operator to lower the trailer assembly 200, such as would be desired at a well site location through activation of cylinder member 232.

FIGS. 2A and 2B also illustrate that a turbine 406 may engage the walls of the tank and extend into the tank interior. Turbine 406 injects O₂ or other reactant gas into the fluids therein for the purpose of reclamation and recycling of polluted and contaminated fluid. One such turbine is Toring Model TT200 available from Varacorp, Austin, Tex.

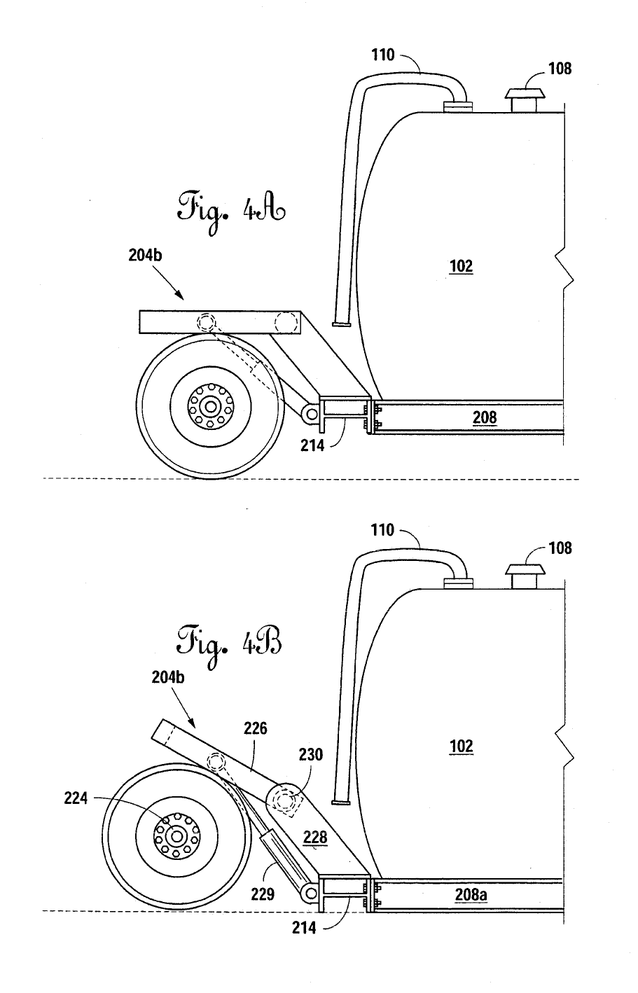

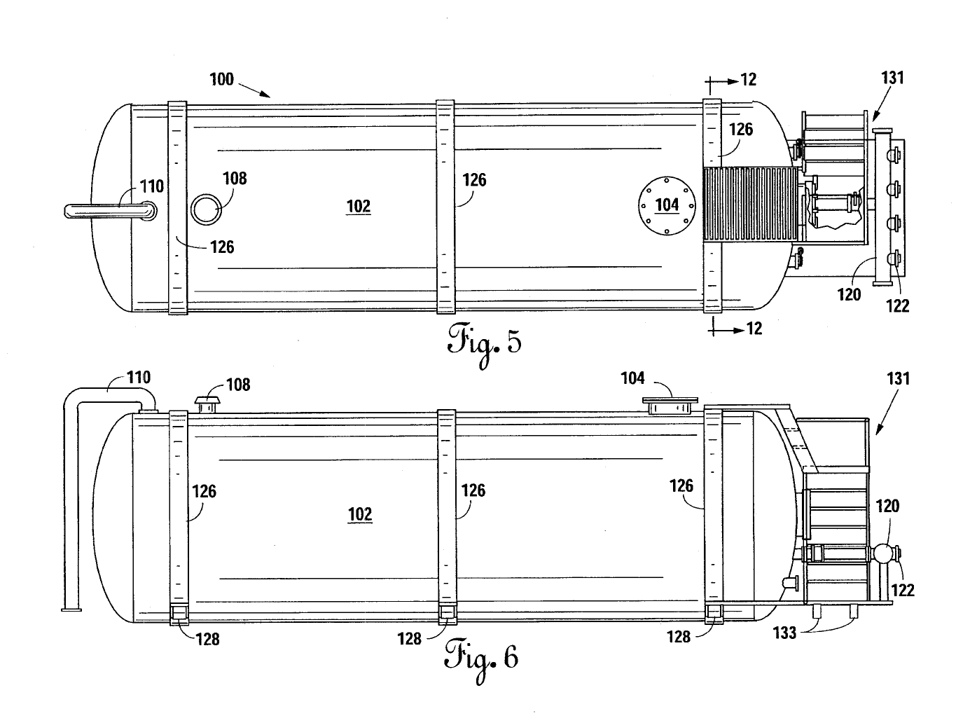

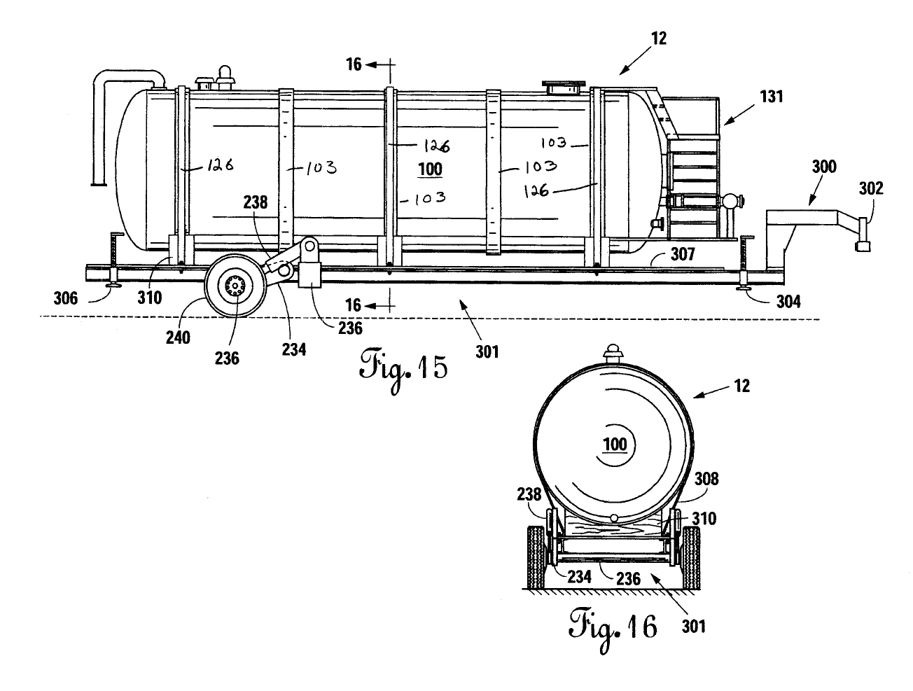

Turning to FIGS. 5 and 6, a multiplicity, here five, hold down straps 126, may be provided as part of the tank assembly whose function it is to secure tank assembly 100 to trailer assembly 200. Securement straps 126 are seen in FIGS. 5 and 6 (strengthening bands 103 not shown). The securement straps 126 are typically cylindrical (for a cylindrical tank) or otherwise conforming to the shape of the tank and may have ears 128 projecting outward as seen in FIGS. 6 and 14 to engage the longitudinal members 208a/208b through the use of fasteners 129 through holes in the ears/frame as seen. This will keep the tank from separating from the trailer while it is being transported. Also illustrated in these figures are step assembly 131 to provide the operator with access to main top opening 104. While the step assembly is seen attached to the tank assembly 100, it is typically separately attached after the tank assembly 100 is attached to the trailer assembly 200 as set forth herein, through the use of mounting elements 133 and fasteners for engagement with elements, truck engagement assembly (see FIGS. 2A and 2B) or in other suitable ways.

FIGS. 7, 8, and 9 illustrate trailer assembly 200 without the tank assembly 100 engaged therewith. Trailer assembly 200 is seen to include longitudinal members 208a/208b, cross-members at cross braces 212 front and 214 rear, and further to include a multiplicity of cradle members 232 formed, as best seen in FIG. 9, to receive the bottom portion of a curved or otherwise configured wall tank member 102. These may provide additional vertical support to the tank member beyond that of straps 126, which are intended to secure the tank to the trailer. Further, cradle members 232 will provide cross bracing and additional support when the tank is a positioned against the ground when it is in use at a well site as seen in FIG. 4B. The trailer assembly is usually configured such that, when it is lowered to the ground at a wall site, the elements of the trailer assembly will keep the tank member off the ground. Lowering the trailer assembly to the ground may be achieved with the moveable rear axle assembly and/or configuring the frame elements low enough to the ground to allow safe transport over the highway yet, when the front of the trailer assembly is unhitched from a tow vehicle and lowered, the longitudinal members and/or the cross-members will keep the tank off the ground.

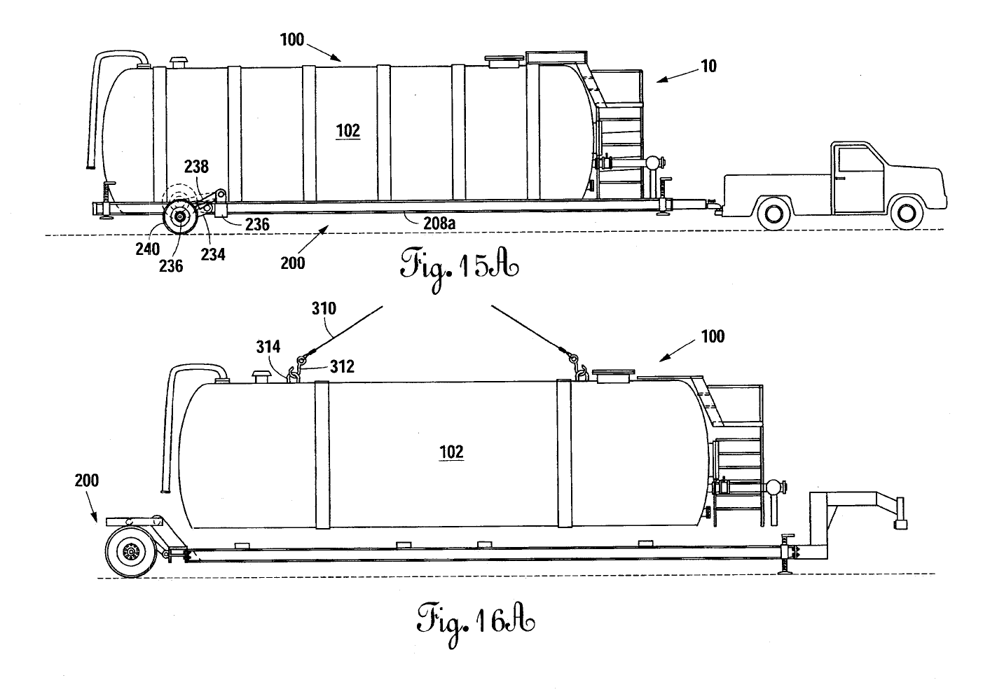

FIGS. 15 and 16 illustrate an alternate embodiment of Applicant's tank/trailer assembly 12. In this alternate embodiment, a standard, commercially available flatbed trailer 301, single or dual axle, is used, typically having a gooseneck or fifth wheel assembly 302 on the front thereof and, optionally, jacks 304/306 included. Here, tank assembly 100 may be secured to the trailer using securement straps 308, which will typically encircle much of the tank assembly 100. In addition, a multiplicity of cradle blocks 210 may be used between the bed of the flatbed and the curved underside of a round tank member 102.

FIG. 17 illustrates that Applicant's novel tank/trailer assembly 10 may be used, in an alternate embodiment, rather than with a gooseneck, simply hooking up to a rear end hitch of a tow vehicle, such as pickup truck PUT. Further, a fifth wheel may be used to engage the trailer to a PUT or tractor.

Examples of possible sizes, weights, and shapes are listed below:
Small (cylindrical): 8′ diameter (height)×30′ long approx. 260 barrels
Tank weight: 3300 lbs. Trailer weight: 5000 lbs.
Full size (cylindrical): 10′ diameter (height)×34″ long approx. 500 barrels
Tank weight: 4500 lbs. Trailer weight: 6000 lbs.
Full size (rectangular): 8′ wide×9′ tall×40′ long approx. 500 barrels
Tank weight: 6500 lbs. Trailer weight: 6500 lbs.

FIGS. 15A and 16A illustrate tank/trailer assembly 10 comprising tank assembly 100a and trailer assembly 200. In the embodiment illustrated, retractable wheel assemblies 234 are provided for engagement through bracket 236 to longitudinal members 208a/208b (only the right side assembly 234 is shown). Retractable wheel assembly 234 includes a stub axle 236 mounted through bracket 236 or other hardware to a hydraulic assembly 238, which typically includes one or more hydraulic elements and rigid elements in the nature of retractable gears on an aircraft. Retractable wheel assemblies 238 typically do not use a straight through axle and thus allows the retraction of tires 240 and the subsequent lowering of the frame of the trailer assembly to the ground when the tank/trailer assembly is transported to the worksite.

FIG. 16A illustrates how cables 310 with T-hooks 312 thereupon may be used to engage hook eyes 313 attached to or built into walled member 102 in order to remove, as by a crane or other mechanical device, the tank assembly 100 from the trailer assembly 200. This may be done after removing the securement straps or other members which engage the walled tank member to the trailer assembly, as by fasteners or the like.

FIG. 17 illustrates the assembly 10 at a worksite, resting on the ground. A stored fluid SF having a fluid level L is shown in the interior of the walled composite tank member 102. The stored fluid may be: fracking fluids, hydrochloric acid or other corrosive or contaminated fluids.

Due to the massive amounts of water needed for fracing the addition of an aerator, such as a self-aspirating aerator to the frac tank assembly, is provided for the primary purpose of reuse or reclamation of polluted or contaminated fluids. One example of an aerator turbine is the Toring turbine model tt220 available from VaraCorp, Austin, Tex. This type of aerator introduces microscopic fine and ultra small bubbles of oxygen containing air beneath the surface to provide dissolved oxygen or other reactant gas. In one example, dissolved oxygen is used to rapidly increase aerobic microbes. This is needed to help remove some of the chemicals and bio-mass in frac flow-back water so that the majority of it can be reused.

Currently practices are to haul all flow-back and production water offsite to disposal wells. The cost for this portion of drilling and completion operations could be significantly reduced by the use of a turbine and the tank. With continued use during production, this may reduce lift costs as well. Aeration systems currently in use are permanent installations, such as wastewater facilities, golf course ponds, animal waste lagoons, shrimp and fish farms, and the like. The lightweight and portability of the tank assembly allows this unit to be relocated with a pickup truck as needed. High dissolved oxygen levels produced during operation of the aerator will rapidly eat through metal tanks unless coated with expensive anti-oxidation products which, over time, chip off and wear off of the treated surface. The composite tank is resistant to oxidation which makes the assembly even most cost effective.

Applicant provides a novel method of portable treatment as needed for all types of wastewater applications where high levels of dissolved oxygen or other gas is needed to help clean the water for reintroduction into the environment or reuse in high water use operations. The portability also makes this system a viable option in containing many hazardous spills.

When water is injected into a formation during the frac process, it picks up contaminants naturally present, such as calcium bicarbonate, magnesium sulfate, strontium, sodium chloride, iron, and barium. In addition, the returning fluid contains heavy metals, soap, radiation, and other components. When sufficient amounts of dissolved oxygen are introduced into the contained frac water and allowed adequate contact time, the water changes from an anaerobic to aerobic state. The treatment process then follows two pathways. First, the dissolved oxygen kills anaerobes, such as sulfate reducing bacteria (SRB). In turn, the dissolved oxygen supports the growth of aerobes that will digest floating or subsurface hydrocarbons, bringing clarify to the water. Second, the dissolved oxygen transforms solids, such as iron and manganese, to their oxidized states which allows them to be removed or settle to the bottom of the tank. Oxygen also is known to oxidize dissolved contaminants, such as hydrogen sulfide. It can remove volatile gaseous compounds, such as ammonia and carbon dioxide, and many others.

FIGS. 2A and 2B illustrate Applicant's use of an aerator turbine 406 in conjunction with the frac tank. The tubine typically includes a motor-driven impeller to pump oxygen from the atmosphere into the frac water in the frac tank. A turbine 406 may include a motor 406a. The motor may be gas, hydraulic, or electric. The motor is typically mounted with its housing to the outer surface of the frac tank. A shaft 406b descends into the stored water in the frac tank and has a turbine rotor 406c at the end of the shaft. In one embodiment, the shaft length is a maximum of 5 feet. The rotating turbine injects oxygen bubbles into the water stored in the frac tank.

Any type of turbine will be suitable. One turbine that has proved effective is the Toring turbine model tt220 which is a self-aspirating aerator that has a high transfer efficiency. Applicant's frac tank may during operation of the turbine/aerator be ventilated with a vent 108 or simply an open manway such as manway 104.

Applicant's non-metallic frac tank avoids problems that might occur when an aerator is used with a metallic frac tank. In such a scenario, the interior of the metallic frac tank would have to be coated with a durable epoxy, otherwise the chemicals generated by the introduction of oxygen would quickly corrode the inner walls of the metal tank. Even with an epoxy lining, the water can lift off the epoxy and corrode the tank.

Applicants have found that one turbine may be sufficient for an 8-by-30-foot tank, about 12,500 gallons (typically 8,000 to 15,000 gallons). While one turbine may work with up to 22,000 gallons, two or may be used for greater efficiency for any size tank.

Turbine 406 may be mounted on the top of the tank and be used with a horizontal placement of the tank rather than a vertical placement of the tank. The shaft 406b of the turbine is typically about three to four feet long. A longer shaft is better to get deeper into the frac water. Typically, shafts within about a foot to five feet of the bottom of the frac tank may be used. A timer 406d may be used with an electrical turbine to periodically aerate the frac water in the tank. The aerator or turbine is run sufficiently over a period fo time to maintain a general aerobic condition in the tank.

Applicant's frac tank may also be used at municipal sewage treatment plants, for overflow purposes. When the demand on the sewage treatment plant is too great, Applicant's frac tank or tanks may be brought in empty and placed horizontally adjacent the municipal treatment plant and used to receive sewage. With the aerator or turbine thereon, they may be used to maintain the sewage in a general aerobic condition. The oxygen, as from the air, introduced into the frac water in Applicant's frac tank will encourage the growth of good (aerobic) bacteria that feeds on the oxygen. The oxygen will also help remove certain chemicals in the frac water.

One model of turbine that has proven effective is the Toring turbine, model TT220, Slovenia, Europe. These are available from VaraCorp. They can deliver up to 18 liters of air per second. They may run on electrical power such as 60 hz motors and may range from 1.5 to 5.0 horsepower. Preferred shaft length is about 3-6 feet. The turbine may be self-aspirated or blower-assisted.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A frac tank and trailer assembly comprising:
a tank assembly; and
a trailer assembly adapted to engage the tank assembly;
wherein the tank assembly includes a substantially longitudinal walled tank member adapted to engage the trailer assembly, the tank assembly made at least in part of a composite material, the composite comprising a substrate and a gel or resin.

2. The frac tank and trailer assembly of claim 1, wherein the substrate is fiberglass.

3. The frac tank and trailer assembly of claim 1, wherein the gel or resin comprise, at least in part, vinyl ester.

4. The frac tank and trailer assembly of claim 1, wherein the substrate is fiberglass; and wherein the gel or resin comprise, at least in part, vinyl ester.

5. The frac tank and trailer assembly of claim 1, wherein the walled tank member weighs between about 3,000 and 10,000 pounds and is adapted to receive, in an interior thereof, of between about 10,000 and 24,000 gallons of fluid.

6. The frac tank and trailer assembly of claim 1, further including coupling members adapted to removably couple the walled tank member from the trailer assembly.

7. The frac tank and trailer assembly of claim 1, wherein the trailer assembly includes a rear axle assembly adapted to lower the tank member to the ground.

8. The frac tank and trailer assembly of claim 1, wherein the trailer assembly includes longitudinal members and cross-braces.

9. The frac tank and trailer assembly of claim 1, wherein the trailer assembly includes a gooseneck member.

10. The frac tank and trailer assembly of claim 1, wherein the walled tank member is cylindrical and includes strengthening straps and wherein the trailer assembly includes cradle members.

11. The frac tank and trailer assembly of claim 1, wherein the substrate is a fiberglass substrate and includes wound filament.

12. The frac tank and trailer assembly of claim 1, wherein the substrate is a fiberglass substrate and includes hand laid cloth.

13. The frac tank and trailer assembly of claim 1, wherein the substrate is a fiberglass substrate and includes chopped fiberglass.

14. The frac tank and trailer assembly of claim 11, wherein the gel or resin is partly vinyl ester.

15. The frac tank and trailer assembly of claim 12, wherein the gel or resin is partly vinyl ester.

16. The frac tank and trailer assembly of claim 13, wherein the gel or resin is partly vinyl ester.

17. The frac tank and trailer assembly of claim 1, wherein the walled tank member further includes a turbine.

18. The frac tank and trailer assembly of claim 1, wherein the trailer assembly includes a retractable wheel assembly.

19. A frac tank and trailer assembly comprising:
a tank assembly; and
a trailer assembly;
wherein the tank assembly includes a walled tank member made at least in part of a composite material, the composite comprising fiberglass substrate and a gel or resin, the gel or resin comprising, at least in part, vinyl ester;
wherein the walled tank member weighs (empty) between 4,000 and 10,000 pounds and is adapted to receive, in an interior thereof, of between 10,000 and 24,000 gallons of fluid;
further including coupling members adapted to removably couple the walled tank member from the trailer;
wherein the trailer assembly includes a rear axle assembly adapted to lower the tank member;
wherein the trailer assembly includes longitudinal members and cross-braces configured to engage the walled tank member;
wherein the trailer assembly includes a gooseneck member; and
wherein the walled tank member is cylindrical and includes strengthening straps and wherein the trailer assembly includes cradle members.

20. The frac tank and trailer assembly of claim 18 wherein the fiberglass substrate includes wound filament; and wherein the gel or resin is partly vinyl ester.

21. The frac tank and trailer assembly of claim 18, wherein the fiberglass substrate includes hand laid cloth; and wherein the gel or resin is partly vinyl ester.

22. The frac tank and trailer assembly of claim 18, wherein the fiberglass substrate includes chopped fiberglass; and wherein the gel or resin is partly vinyl ester.

23. The frac tank and trailer assembly of claim 18, wherein the tank assembly includes a turbine.

24. The frac tank and trailer assembly of claim 18, further including a gooseneck or fifth wheel connection and a pickup truck.

25. The frac tank and trailer assembly of claim 1, wherein the walled tank member contains a stored fluid and is resting on a support surface.
